(19) United States
(12) Patent Application Publication
(10) Pub. No.: US 2025/0078473 A1
(43) Pub. Date: Mar. 6, 2025

(54) APPARATUS FOR COLLECTING TRAINING DATA FOR IMAGE LEARNING AND METHOD THEREOF

(71) Applicants: Hyundai Motor Company, Seoul (KR); Kia Corporation, Seoul (KR)

(72) Inventors: Min Young Yoon, Seoul (KR); Jung Woo Heo, Suwon-si (KR)

(21) Appl. No.: 18/621,230

(22) Filed: Mar. 29, 2024

(30) Foreign Application Priority Data
Aug. 29, 2023 (KR) 10-2023-0114013

(51) Int. Cl. G06V 10/774; G06V 10/26; G06V 10/764; G06V 10/776; G06V 10/82; G06V 20/56; G06V 20/70

(52) U.S. Cl. CPC G06V 10/774; G06V 10/26; G06V 10/764; G06V 10/776; G06V 10/82; G06V 20/56; G06V 20/70

(57) ABSTRACT

Disclosed are an apparatus for collecting training data for image learning and a method thereof. The apparatus may recognize, via an interest network, an object of interest corresponding to a predetermined class by learning an image provided from a vehicle, obtain, via the interest network, one or more reliability scores indicating reliability with which the object of interest is recognized, perform, via an auxiliary network, a learning process associated with the image and detect, in the image, an occlusive object that affects a learning result of the interest network, and determine whether to label the image based on whether the occlusive object is detected and the one or more reliability scores.

### CROSS-REFERENCE TO RELATED APPLICATION

This application claims the benefit of priority to Korean Patent Application No. 10-2023-0114013, filed in the Korean Intellectual Property Office on Aug. 29, 2023, the entire contents of which are incorporated herein by reference.

### TECHNICAL FIELD

The present disclosure relates to an apparatus for collecting training data for image learning and a method thereof.

### BACKGROUND

An autonomous vehicle refers to a vehicle that is operable by itself without the manipulation of a driver or a passenger, and an autonomous driving system refers to a system that monitors and controls such an autonomous vehicle to operate by itself. Generally, an autonomous vehicle may refer to a vehicle that monitors the external environment of the vehicle to assist the driver in driving and is equipped with various driving assistance devices based on the monitored external environment of the vehicle.

An autonomous vehicle or a vehicle equipped with a driving assistance device monitors the exterior of the vehicle to detect an object, and controls the vehicle based on a scenario determined according to the detected object. In other words, autonomous driving or assisted driving (e.g., using a driving assistance device) is generally premised on the process of determining the type of object outside the vehicle.

In order to recognize an object outside a vehicle, a deep learning scheme using information obtained from sensors is commonly used. The object recognition performance of a network may deteriorate due to recognition vulnerable occlusive objects that negatively affect object recognition, such as rainwater included in an image, dust, camera contamination, and the like. Therefore, in order to improve object recognition performance, it is necessary to learn images containing occlusive objects.

The task of selecting images including occlusive objects is generally performed by a person. Images including occlusive objects exist at a very low rate compared to all images obtained by a vehicle. Therefore, in order to select occlusive objects from images acquired by a vehicle, a large number of images must be checked, which may require a lot of labor and time.

In addition, an image including an occlusive object may be artificially created, but in this case, it is difficult to fully reflect the characteristics of the image obtained during actual driving of the vehicle, so there is a limit to improving the learning performance of a network.

### SUMMARY

The present disclosure has been made to solve the above-mentioned problems in some embodiments while advantages achieved by those embodiments are maintained intact.

An aspect of the present disclosure provides an apparatus and method for collecting training data for image learning capable of selecting training data that directly affects the improvement of recognition performance of an image learning network.

Another aspect of the present disclosure provides an apparatus and method for collecting training data for image learning capable of reducing the labor and time of the procedure for selecting image training data.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, an apparatus may include: one or more processors; and memory. The memory may store instructions that, when executed by the one or more processors, cause the apparatus to: recognize, via an interest network, an object of interest corresponding to a predetermined class by learning an image provided from a vehicle; and obtain, via the interest network, one or more reliability scores indicating reliability with which the object of interest is recognized; perform, via an auxiliary network, a learning process associated with the image and detect, in the image, an occlusive object that affects a learning result of the interest network; and determine whether to label the image based on: whether the occlusive object is detected, and the one or more reliability scores.

The instructions, when executed by the one or more processors, may cause the apparatus to determine whether to label the image based on the one or more reliability scores by: determining whether to label the image based on: a first reliability score indicating accuracy of segmentation of the image, and a second reliability score indicating accuracy of detecting the object of interest being output into a bounding box.

The instructions, when executed by the one or more processors, may further cause the apparatus to: obtain entropy of each pixel of the image; determine, based on the entropy of each pixel of the image, a representative entropy value; and determine the first reliability score. The first reliability score may be inversely proportional to the representative entropy value.

The instructions, when executed by the one or more processors, may further cause the apparatus to: obtain entropy of at least one bounding box in the image; and determine the second reliability score. The second reliability score may be inversely proportional to the entropy of the at least one bounding box.

The instructions, when executed by the one or more processors, may cause the apparatus to determine whether to label the image by: determining the first reliability score and the second reliability score based on recognition of the occlusive object through learning of the auxiliary network; and determining to label the image for learning of the auxiliary network, based on at least one of the first reliability score or the second reliability score being less than a threshold value.

The instructions, when executed by the one or more processors, may cause the apparatus to determine whether to label the image by: excluding the image from training data of the interest network and the auxiliary network based on the first reliability score and the second reliability score being greater than or equal to a threshold value.

The instructions, when executed by the one or more processors, may cause the apparatus to determine whether to label the image by: determining the first reliability score based on the occlusive object being not detected by learning of the auxiliary network; and determining to label the image for learning of the auxiliary network based on the first reliability score being less than a threshold value.

The instructions, when executed by the one or more processors, may further cause the apparatus to: determine the second reliability score based on the first reliability score being greater than or equal to a threshold value; and determine to add a new class of the interest network based on the second reliability score being less than the threshold value.

The instructions, when executed by the one or more processors, may further cause the apparatus to determine whether to label the image by: determine to label the image for learning the interest network based on the first reliability score and the second reliability score being greater than or equal to a threshold value.

The instructions, when executed by the one or more processors, may further cause the apparatus to determine whether the occlusive object is detected based on the first reliability score and the second reliability score being less than a threshold value.

According to one or more example embodiments of the present disclosure, a method may include: recognizing, via an interest network, an object of interest corresponding to a predetermined class by learning an image from a vehicle; obtaining, via the interest network, one or more reliability scores with which the object of interest is recognized; performing, via an auxiliary network, a learning process associated with the image and detecting, in the image, an occlusive object that affects a learning result of the interest network; and determining whether to label the image based on: whether the occlusive object is detected, and the one or more reliability scores.

Recognizing the object of interest may include: determining a first reliability score indicating accuracy of segmentation; and determining a second reliability score indicating accuracy of detecting the object of interest being output into a bounding box.

Determining the first reliability score may include: obtaining entropy of each pixel of the image; determining, based on the entropy of each pixel of the image, a representative entropy value; and determining the first reliability score. The first reliability score may be inversely proportional to the representative entropy value.

Determining the second reliability score may include: obtaining entropy of at least one bounding box in the image; and determining the second reliability score. The second reliability score may be inversely proportional to the entropy of the at least one bounding box.

Determining whether to label the image may include: determining the first reliability score and the second reliability score based on recognition of the occlusive object through learning of the auxiliary network; and determining to label the image for learning of the auxiliary network, based on at least one of the first reliability score or the second reliability score being less than a threshold value.

Determining whether to label the image may include: excluding the image from training data of the interest network and the auxiliary network based on the first reliability score and the second reliability score being greater than or equal to a threshold value.

Determining whether to label the image may include: determining the first reliability score based on the occlusive object being not detected by learning of the auxiliary network; and determining to label the image for learning of the auxiliary network based on the first reliability score being less than a threshold value.

Recognizing the object of interest may include: determining the second reliability score based on the first reliability score being greater than or equal to a threshold value. The method may further include: determining to add a new class of the interest network based on the second reliability score being less than the threshold value.

Determining whether to label the image may include: determining to label the image for learning the interest network based on the first reliability score and the second reliability score being greater than or equal to a threshold value.

Determining the first reliability score and the second reliability score may be performed before the detecting of the occlusive object. Detecting the occlusive object may include detecting the occlusive object based on the first reliability score and the second reliability score being less than a threshold value.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic diagram illustrating a method of collecting training data for image learning;

FIG. 2 is a diagram illustrating a vehicle capable of obtaining an image outside a vehicle during driving;

FIG. 3 is a diagram illustrating a method of constructing a learning model for image learning;

FIG. 4 is a block diagram illustrating the configuration of a curation device;

FIG. 5 is a diagram illustrating image segmentation performed by the first network;

FIG. 6 is a diagram illustrating a bounding box output by the second network;

FIG. 7 is a diagram illustrating the type of a recognition vulnerable object detected in the auxiliary network;

FIG. 8 is a flowchart illustrating a method of collecting training data;

FIG. 9 is a flowchart illustrating a method of determining whether to proceed with labeling of an image;

FIG. 10 is a diagram illustrating an example of an image excluded from training data;

FIG. 11 is a flowchart illustrating a method of determining whether to proceed with labeling of an image; and

FIG. 12 is a diagram illustrating a method of determining whether to proceed with labeling of an image.

FIG. 13 shows an example computing system for collecting training data and image learning.

### DETAILED DESCRIPTION

Hereinafter, one or more example embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the example embodiment of the present disclosure, a detailed description of the related known configuration or function will be omitted when it is determined that it interferes with the understanding of the example embodiment of the present disclosure.

In addition, terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

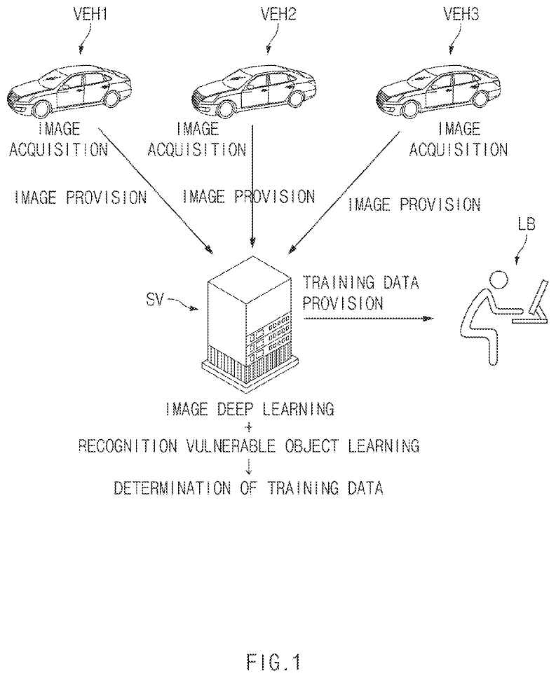

Hereinafter, one or more example embodiments of the present disclosure will be described in detail with reference to FIGS. 1 to 12.

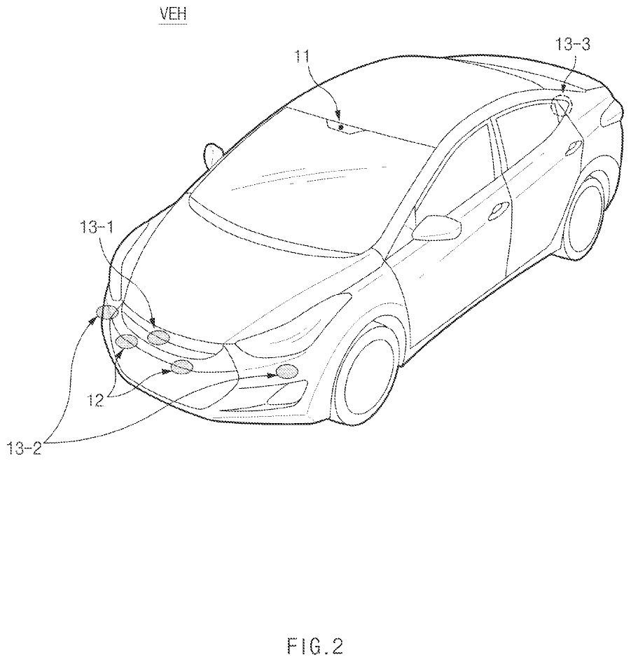

FIG. 1 is a schematic diagram illustrating a method of collecting training data for image learning. FIG. 2 is a diagram illustrating a vehicle capable of obtaining an image outside a vehicle during driving.

Referring to FIG. 1, a server SV for collecting training data for image learning may receive images from vehicles.

As shown in FIG. 2, each of vehicles VEH1, VEH2, and VEH3 may include at least one of a camera 11, a light imaging detection and ranging (lidar) 12, and a radio detection and ranging (radar) 13 in order to detect an object outside a vehicle VEH.

The camera 11, which is used to obtain an external image of the vehicle VEH, may obtain a front image or front and side images of the vehicle VEH. For example, the camera 11 may be arranged around the front windshield to obtain a front image of the vehicle VEH.

The lidar 12, which is provided to transmit a laser and determine an object by using the reflected wave of the laser reflected from the object, may be implemented in a time-of-flight (TOF) scheme or a phase-shift scheme. The lidar 12 may be mounted to be exposed to the outside of the vehicle and may be arranged around the front bumper or front grill.

The radar 13 may include an electromagnetic wave transmission module and a reception module. The radar 13 may be implemented in a pulse radar scheme or a continuous wave radar scheme based on the principle of transmitting radio waves. The radar 13 may be implemented in a frequency modulated continuous wave (FMCW) scheme or a frequency shift keying (FSK) scheme depending on the signal waveform among the continuous wave radar schemes. The radar 13 may include a front radar 13-1 located at the front center of the vehicle VEH, a front side radar 13-2 located at both ends of the front bumper, and a rear radar 13-3 located at the rear of the vehicle VEH.

The locations of the camera 11, the lidar 12, and the radar 13 may not be limited to what is shown in FIG. 2.

In addition, sensors of the vehicle VEH may include an ultrasonic sensor and an infrared sensor.

The images provided from the vehicles VEH1, VEH2, and VEH3 to the server SV may be data obtained by fusing the image acquired by the camera 11 and the information acquired by the lidar 12 or the information acquired by the radar 13.

The server SV may perform deep learning on images provided from the vehicles VEH1, VEH2, and VEH3 by using the interest network.

In addition, the server SV may learn images by using an auxiliary network and detect, in the images, an occlusive object. As used herein, an occlusive object in an image may be any object or artifact that negatively affects (e.g., hinders, prevents, obstructs, etc.) object recognition within the image. Occlusive objects may be factors that may reduce the accuracy of deep learning of the interest network and may include dust, rainwater, liquid, light blur, contaminant, and the like.

Depending on the learning results of the interest network and the auxiliary network, the server SV may determine whether to use the image as training data for the interest network or the auxiliary network.

The server SV may provide the image determined as training data to a labeler LB.

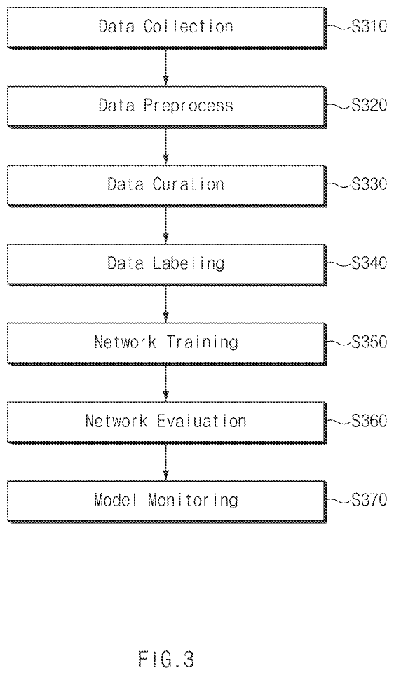

FIG. 3 is a diagram illustrating a method of constructing a learning model for image learning.

Referring to FIG. 3, a learning model for image learning may be constructed based on machine learning operations (Mlops).

In S310, data collection may be a procedure of obtaining surrounding information. The surrounding information may be images obtained while the vehicle is driven, or may be obtained in a simulation environment.

In S320, data preprocess may be a procedure of processing an image. The data preprocess may include procedures for converting and processing the dimensions of the image, and may include procedures for adding metadata to the image. In addition, data preprocessing may include a procedure for fusing LIDAR information or radar information into the image.

In S330, data curation may be a process of selecting data for network learning.

In S340, data labeling may be a procedure of labeling images determined as training data, and may be a task performed by a person.

In S350, network training may be a procedure of learning images for which labeling work is completed.

In S360, network evaluation may be a procedure of evaluating a network model based on an image learning result.

In S370, model monitoring may be a procedure of monitoring the prediction performance of a network model.

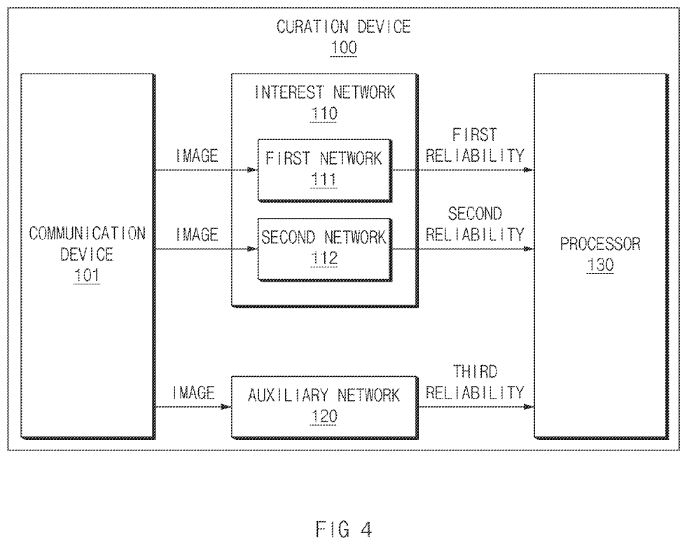

As shown in FIG. 4 to be described below, the server SV may include a curation device 100 and select training data by using the curation device 100. The curation device 100 will be described below with reference to FIG. 4.

FIG. 4 is a block diagram illustrating the configuration of a curation device.

Referring to FIGS. 1 and 4, the curation device 100 may include a communication device 101, an interest network 110, an auxiliary network 120, and a processor 130.

The communication device 101 may receive images from the vehicles VEH1, VEH2, and VEH3 or an outside. The communication device 101 may provide images to the interest network 110 and the auxiliary network 120.

The communication device 101 may transmit and receive radio signals with the vehicles VEH1, VEH2, and VEH3 on a mobile communication network constructed according to technical standards or communication schemes for mobile communication. For example, the communication device 101 may perform communication based on global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTEA), and the like.

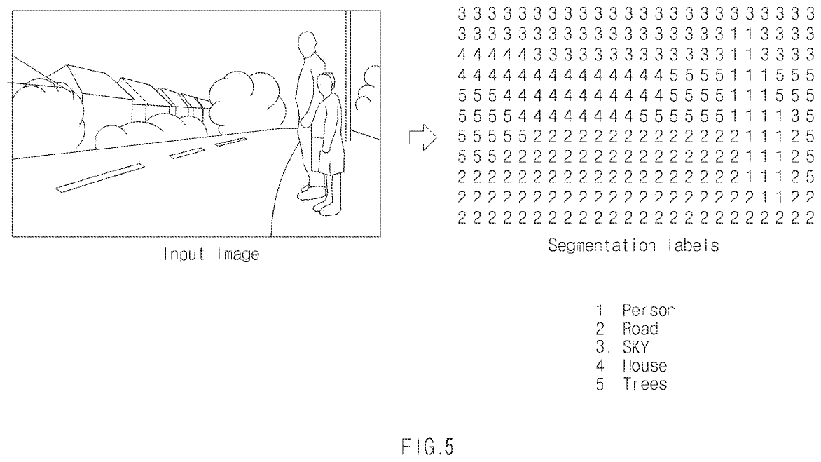

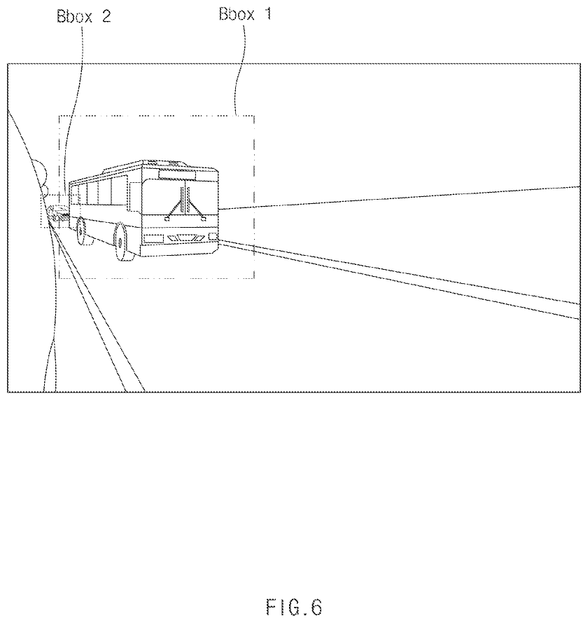

The interest network 110 may detect objects (e.g., objects of interest) or classify classes of pixels by deep learning images. To this end, the interest network 110 may include at least one of a first network 111 and a second network 112. The learning results of the interest network 110 will be described below with reference to FIGS. 5 and 6.

FIG. 5 is a diagram illustrating image segmentation performed by the first network. FIG. 6 is a diagram illustrating a bounding box output by the second network.

The first network 111 of the interest network 110 may be a network model that performs image segmentation. As shown in FIG. 5, the first network 111 may perform image segmentation and assign a class to each pixel of an image. The label may be for classifying a predetermined class.

As shown in FIG. 6, the second network 112 of the interest network 110 may learn an image and express the location of the object detected in the image as a square box.

In addition, the interest network 110 may obtain a reliability score according to image deep learning results. For example, the first network 111 may obtain a first reliability score according to the deep learning result, and the second network 112 may obtain a second reliability score. The first reliability score may indicate the accuracy of segmentation. In addition, the second reliability score may indicate the accuracy of object detection output as a bounding box.

The auxiliary network 120 may detect an occlusive object that affects the learning result of the interest network.

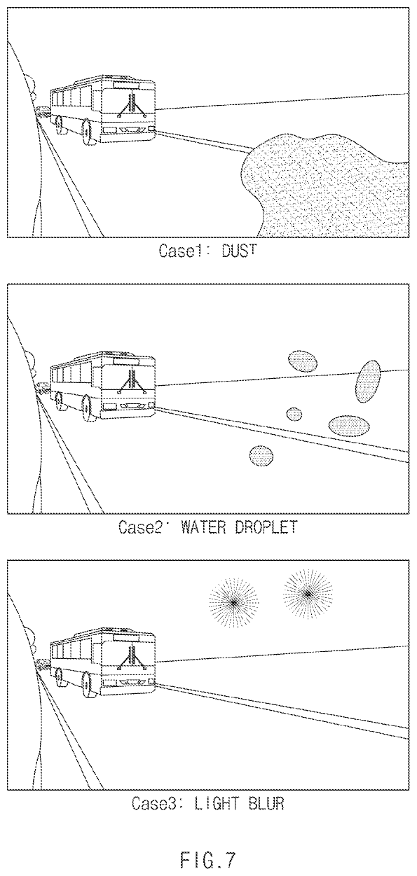

FIG. 7 is a diagram illustrating the type of an occlusive object detected in the auxiliary network.

Referring to FIG. 7, the auxiliary network 120 may detect dust as in Case 1. In addition, the auxiliary network 120 may detect water droplets as in Case 2 and light blur as in Case 3.

The auxiliary network 120 may detect occlusive objects in units of pixel units in the image.

The processor 130 may determine whether to proceed with labeling of an image based on whether an occlusive object is detected and the reliability score. The image labeling may be a process of assigning a specific value to training data before learning images. The image labeling may be a necessary procedure to generate correct answer data for supervised learning.

To this end, the processor 130 may include an artificial intelligence (AI) processor for image learning. The AI processor may learn a neural network by using a pre-stored program. A neural network for detecting a target vehicle and a dangerous vehicle may be designed to simulate a human brain structure on a computer, and may include a plurality of network nodes having weights that simulate neurons of a human neural network. A plurality of network nodes may transmit and receive data according to a connection relationship to allow a neuron to simulate the synaptic activity of the neuron that transmits and receives a signal through a synapse. The neural network may include a deep learning model developed from a neural network model. In a deep learning model, a plurality of network nodes may transmit and receive data according to a convolutional connection relationship while being located in different layers. For example, a neural network model may include various deep learning schemes such as a deep neural network (DNN), a convolutional deep neural network (CNN), a recurrent neural network (RNN), a restricted Boltzmann machine (RBM), a deep belief network (DBN), a deep Q-network, and the like. An interest network may be a neural network implemented with one or more processors. An auxiliary network may be a neural network implemented with one or more processors.

The processor 130 may include a memory (not shown) for storing an AI processor, an algorithm, and the like. The memory may use a hard disk drive, a flash memory, an electrically erasable programmable read-only memory (EEPROM), a static RAM (SRAM), a ferro-electric RAM (FRAM), a phase-change RAM (PRAM), a magnetic RAM (MRAM), a dynamic random access memory (DRAM), a synchronous dynamic random access memory (SDRAM), a double date rate-SDRAM (DDR-SDRAM), and the like.

Image labeling may be performed on images determined as training data.

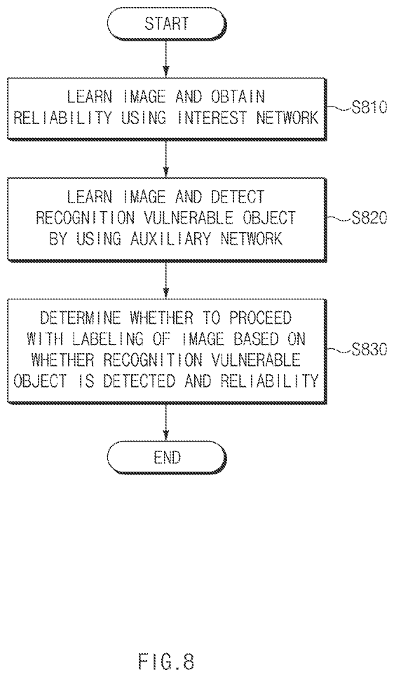

FIG. 8 is a flowchart illustrating a method of collecting training data. The procedures shown in FIG. 8 may be procedures included in the data curation process shown in FIG. 3. Hereinafter, a method of collecting training data will be described with reference to FIG. 8.

In S810, the interest network 110 may learn an image and obtain a reliability score according to the learning result.

The reliability score may include at least one of the first reliability score output from the first network 111 and the second reliability score output from the second network 112.

The first reliability score may indicate the accuracy of segmentation.

To obtain the first reliability score, the first network may obtain the entropy of each pixel of the image. The entropy may represent the uncertainty of labeling given to pixels. For example, as a result of segmentation, a first pixel may have a 25% probability of being a human and a 20% probability of being a dog. When a second pixel contains an 85% probability of being a human and a 2% probability of being a dog, the entropy of the first pixel may be calculated to be higher than that of the second pixel.

The first network 111 may obtain a representative entropy value of an image based on the entropy of each pixel. For example, the representative entropy e value may be the average entropy of pixels included in the image. Alternatively, the representative entropy value may be the total entropy of pixels.

The second reliability score may be calculated based on the entropy of the bounding box.

The entropy of the bounding box may be calculated based on the uncertainty of the bounding box. For example, the second network 112 may obtain a confidence score indicating the probability that an object exists inside the bounding box. The entropy of the bounding box may be inversely proportional to the confidence score, and the second reliability score may be determined to be proportional to the confidence score.

In S820, the auxiliary network 120 may learn an image and detect an occlusive object.

In S830, the processor 130 may determine whether to proceed with labeling of the image based on whether an occlusive object is detected and the reliability score output by the interest network.

As described herein, it is possible in the Mlops process to use the image learning results of the interest network and the auxiliary network to collect training data of the deep learning network. Training data may be selected from images obtained while vehicles are actually driven. In particular, because the training data is selected based on the reliability score obtained through image learning, it is possible to select images that affect the learning of the interest network or auxiliary network. Therefore, it is possible to select training data that has a greater impact on object recognition performance. In addition, because images for learning occlusive objects are not manually created by humans, it is possible to reduce the time and cost of preparing training data.

Hereinafter, an example of determining whether to proceed with labeling of an image will be described.

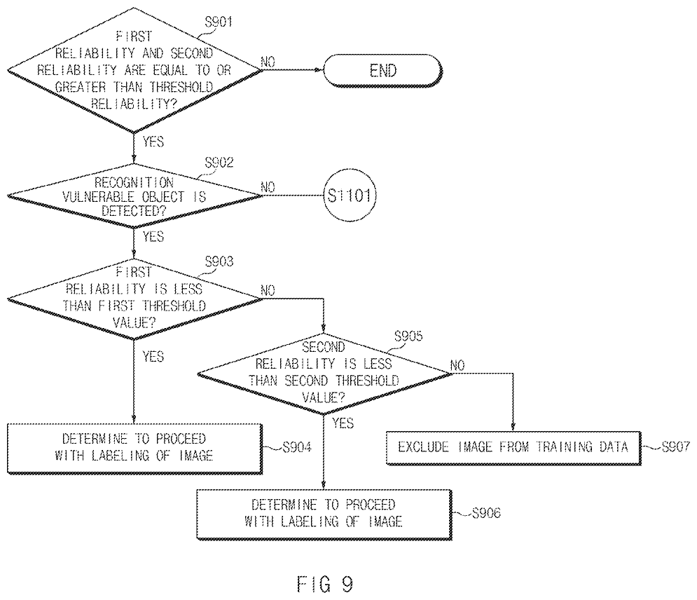

FIG. 9 is a flowchart illustrating a method of determining whether to proceed with labeling of an image. FIG. 9 illustrates procedures performed by a processor. With reference to FIG. 9, a method of determining whether to proceed with labeling of an image will be described below.

In operation S901, after learning of the interest network for an image is completed, the processor 130 may determine whether both the first reliability score and the second reliability score are equal to or greater than a threshold reliability score.

The threshold reliability score may be determined as a degree at which the accuracy of the learning result of the first network and the learning result of the second network may be doubted. For example, although the class is classified by learning of the first network, the accuracy may not be guaranteed. In addition, although the bounding box and the class of the bounding box are matched by learning of the second network, the accuracy may not be guaranteed. The threshold reliability score may be set around 50%.

In operation S902, the processor 130 may determine whether an occlusive object is detected in an image.

In operation S903, the processor 130 may determine whether the first reliability score is less than the first threshold value based on the detected occlusive object.

As shown in FIG. 7, when the auxiliary network 120 detects an occlusive object such as dust, water droplets, light blur, and the like, the processor 130 may identify the first reliability score.

In S904, the processor 130 may determine the image as training data for the auxiliary network based on the fact that the first reliability score is less than the first threshold value. In addition, the processor 130 may determine to perform labeling of an image.

The first threshold value may be set to a degree at which it is determined that the class matched to the pixel is uncertain based on the segmentation result, and may be set to a degree lower than the threshold reliability score.

Although an occlusive object is detected by the auxiliary network, when the first reliability score of the first network is low, it may be determined that segmentation is not performed smoothly due to the occlusive object. Therefore, because the image classified in operation S904 causes a decrease in the recognition performance of the first network, the image may be selected as a target for learning an occlusive object.

In S905, the processor 130 may identify the second reliability score based on the fact that the first reliability score is greater than or equal to the first threshold value.

In S906, the processor 130 may determine the image as training data for the auxiliary network based on the fact that the second reliability score is less than the second threshold value. In addition, the processor 130 may determine whether to perform labeling of the image.

The second threshold value may be set to a degree at which it may be determined that the bounding box detected by the second network is uncertain, and may be set to a degree lower than the threshold reliability score.

When an occlusive object is detected by the auxiliary network, and the second reliability score of the second network is low, it may be determined that the bounding box is not smoothly created due to the occlusive object. Therefore, because the image classified in operation S906 causes a decrease in the recognition performance of the second network, the occlusive object may be selected as a target for learning an occlusive object.

In S907, the processor 130 may exclude an image from the training data based on the fact that the second reliability score is greater than or equal to the second threshold value.

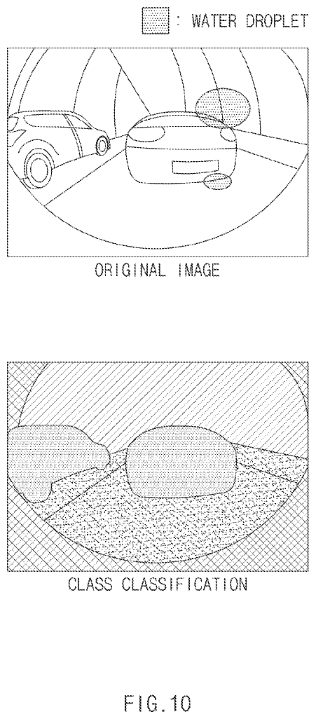

FIG. 10 is a diagram illustrating an example of an image excluded from training data.

Referring to FIG. 10, an original image obtained by a vehicle may be an image obtained by capturing water droplets.

In S907, the classified image classified does not have very high learning reliability by the interest network, but it may be determined that the water droplets do not affect class classification as shown in FIG. 10.

As described herein, even when an occlusive object is detected in the image, and when it does not significantly affect the recognition performance of the interest network, the processor 130 may decide to exclude the image from the training data.

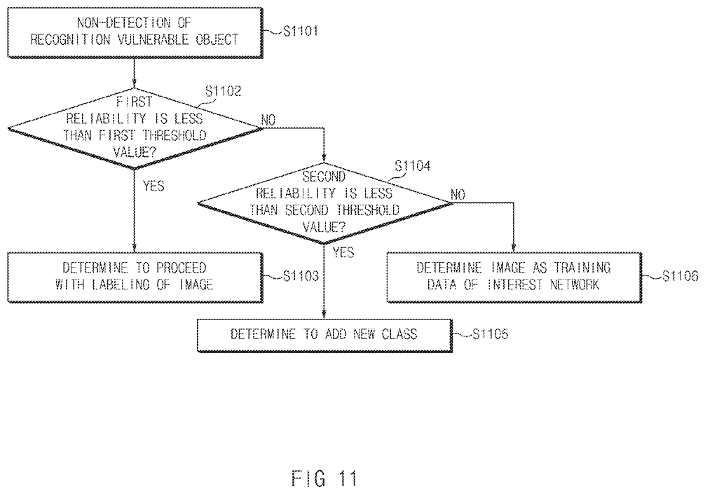

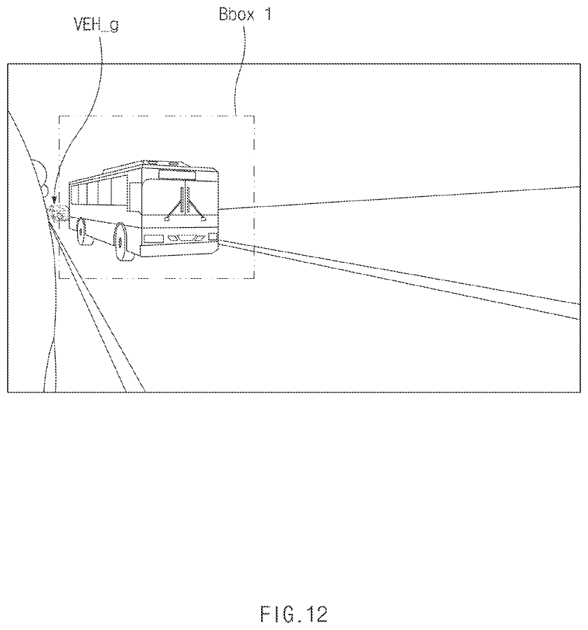

FIG. 11 is a flowchart illustrating a method of determining whether to proceed with labeling of an image. FIG. 11 is a diagram illustrating procedures performed on an image whose first reliability score and second reliability score are greater than or equal to the threshold reliability score after learning of the interest network is completed. FIG. 12 is a diagram illustrating a method of determining whether to proceed with labeling of an image. With reference to FIGS. 11 and 12, a method of determining whether to proceed with labeling of an image will be described below.

In operations S1101 and S1102, the processor 130 may determine whether the first reliability score is less than the first threshold value based on the fact that the occlusive object is not detected in the image.

In S1103, the processor 130 may determine the image as training data of the auxiliary network based on the fact that the first reliability score is less than the first threshold value. In addition, the processor 130 may determine whether to perform labeling of the image.

Even though the occlusive object is not recognized by the auxiliary network, when the first reliability score of the first network is low, it may be determined that segmentation is not smoothly performed due to the occlusive object. For example, as shown in FIG. 12, even though any occlusive objects are not detected, an actual vehicle VEH g included in the image may not be recognized by the first network. Such a phenomenon may occur when the entire image is blurred due to thin rain or dust, or when occlusive objects are not detected and distant objects are not recognized. Therefore, because the image classified in operation S1103 causes a decrease in recognition performance of the first network, the image may be selected as a target for learning occlusive objects.

In operation S1104, the processor 130 may determine whether the second reliability score is less than the second threshold value based on the fact that the first reliability score is greater than or equal to the first threshold value.

In operation S1105, the processor 130 may determine to add a new class based on the fact that the second reliability score is less than the second threshold value.

When the reliability score of the bounding box is low compared to the result of segmentation, the classification of the detected object may be uncertain. For example, as shown in FIG. 12, although the second network detects a vehicle and creates a first bounding box Bbox1, it may not be able to accurately determine the type of the vehicle. As the result, it may be determined that the class of the vehicle divided by the first bounding box ( ) is not defined in advance. Accordingly, the processor 130 may determine that a new class needs to be added to the classified image in operation S1105.

In S1106, the processor 130 may determine the image as training data of the interest network based on the fact that the second reliability score is greater than or equal to the second threshold value.

When no occlusive objects are detected in the image and the recognition performance of the interest network is determined to be acceptable, the image may be determined as training data of the interest network 110, thereby improving the object recognition performance of the interest network 110. Operation S1106 may include an operation of determining a labeling task to use an image as training data for the interest network 110.

Because training data is selected based on the results of detecting occlusive objects in images obtained while a vehicle is driven, it is possible to select training data that directly affects the improvement of the recognition performance of the image learning network.

In addition, because the training data of the image learning network may be selected without the need to generate images containing occlusive objects, labor and time may be significantly reduced.

In addition, various effects that are directly or indirectly understood through the present disclosure may be provided.

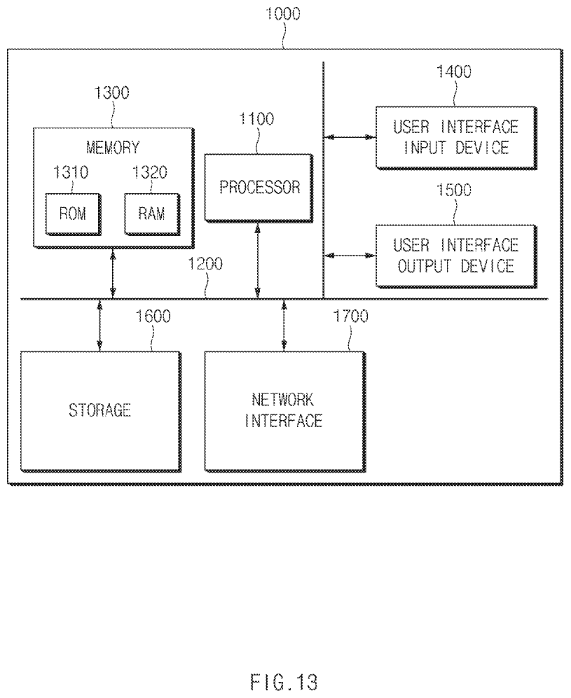

FIG. 13 shows an example computing system for collecting training data and image learning. One or more of an example computing system 1000 may be used to implement the various example embodiments described herein. The computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the one or more example embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

Although one or more example embodiments of the present disclosure have been described for illustrative purposes, those skilled in the art will appreciate that various modifications, additions and substitutions are possible, without departing from the scope and spirit of the disclosure.

Therefore, the example embodiments disclosed in the present disclosure are provided for the sake of descriptions, not limiting the technical concepts of the present disclosure, and it should be understood that such example embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus comprising:
one or more processors; and
memory storing instructions that, when executed by the one or more processors, cause the apparatus to:
recognize, via an interest network, an object of interest corresponding to a predetermined class by learning an image provided from a vehicle; and
obtain, via the interest network, one or more reliability scores indicating reliability with which the object of interest is recognized;
perform, via an auxiliary network, a learning process associated with the image and detect, in the image, an occlusive object that affects a learning result of the interest network; and
determine whether to label the image based on:
whether the occlusive object is detected, and
the one or more reliability scores.

2. The apparatus of claim 1, wherein the instructions, when executed by the one or more processors, cause the apparatus to determine whether to label the image based on the one or more reliability scores by:
determining whether to label the image based on:
a first reliability score indicating accuracy of segmentation of the image, and
a second reliability score indicating accuracy of detecting the object of interest being output into a bounding box.

3. The apparatus of claim 2, wherein the instructions, when executed by the one or more processors, further cause the apparatus to:
obtain entropy of each pixel of the image;
determine, based on the entropy of each pixel of the image, a representative entropy value; and
determine the first reliability score, wherein the first reliability score is inversely proportional to the representative entropy value.

4. The apparatus of claim 2, wherein the instructions, when executed by the one or more processors, further cause the apparatus to:
obtain entropy of at least one bounding box in the image; and
determine the second reliability score, wherein the second reliability score is inversely proportional to the entropy of the at least one bounding box.

5. The apparatus of claim 2, wherein the instructions, when executed by the one or more processors, cause the apparatus to determine whether to label the image by:
determining the first reliability score and the second reliability score based on recognition of the occlusive object through learning of the auxiliary network; and
determining to label the image for learning of the auxiliary network, based on at least one of the first reliability score or the second reliability score being less than a threshold value.

6. The apparatus of claim 2, wherein the instructions, when executed by the one or more processors, cause the apparatus to determine whether to label the image by:
excluding the image from training data of the interest network and the auxiliary network based on the first reliability score and the second reliability score being greater than or equal to a threshold value.

7. The apparatus of claim 2, wherein the instructions, when executed by the one or more processors, cause the apparatus to determine whether to label the image by:
determining the first reliability score based on the occlusive object being not detected by learning of the auxiliary network; and
determining to label the image for learning of the auxiliary network based on the first reliability score being less than a threshold value.

8. The apparatus of claim 2, wherein the instructions, when executed by the one or more processors, further cause the apparatus to:
determine the second reliability score based on the first reliability score being greater than or equal to a threshold value; and
determine to add a new class of the interest network based on the second reliability score being less than the threshold value.

9. The apparatus of claim 2, wherein the instructions, when executed by the one or more processors, further cause the apparatus to determine whether to label the image by:
determine to label the image for learning the interest network based on the first reliability score and the second reliability score being greater than or equal to a threshold value.

10. The apparatus of claim 2, wherein the instructions, when executed by the one or more processors, further cause the apparatus to determine whether the occlusive object is detected based on the first reliability score and the second reliability score being less than a threshold value.

11. A method comprising:
recognizing, via an interest network, an object of interest corresponding to a predetermined class by learning an image from a vehicle;
obtaining, via the interest network, one or more reliability scores with which the object of interest is recognized;
performing, via an auxiliary network, a learning process associated with the image and detecting, in the image, an occlusive object that affects a learning result of the interest network; and
determining whether to label the image based on:
whether the occlusive object is detected, and
the one or more reliability scores.

12. The method of claim 11, wherein the recognizing of the object of interest comprises:
determining a first reliability score indicating accuracy of segmentation; and
determining a second reliability score indicating accuracy of detecting the object of interest being output into a bounding box.

13. The method of claim 12, wherein the determining of the first reliability score comprises:
obtaining entropy of each pixel of the image;
determining, based on the entropy of each pixel of the image, a representative entropy value; and
determining the first reliability score, wherein the first reliability score is inversely proportional to the representative entropy value.

14. The method of claim 12, wherein the determining of the second reliability score comprises:
obtaining entropy of at least one bounding box in the image; and
determining the second reliability score, wherein the second reliability score is inversely proportional to the entropy of the at least one bounding box.

15. The method of claim 12, wherein the determining of whether to label the image comprises:
determining the first reliability score and the second reliability score based on recognition of the occlusive object through learning of the auxiliary network; and
determining to label the image for learning of the auxiliary network, based on at least one of the first reliability score or the second reliability score being less than a threshold value.

16. The method of claim 12, wherein the determining of whether to label the image comprises:
excluding the image from training data of the interest network and the auxiliary network based on the first reliability score and the second reliability score being greater than or equal to a threshold value.

17. The method of claim 12, wherein the determining of whether to label the image comprises:
determining the first reliability score based on the occlusive object being not detected by learning of the auxiliary network; and
determining to label the image for learning of the auxiliary network based on the first reliability score being less than a threshold value.

18. The method of claim 12, wherein the recognizing of the object of interest comprises:
determining the second reliability score based on the first reliability score being greater than or equal to a threshold value, and
wherein the method further comprises:
determining to add a new class of the interest network based on the second reliability score being less than the threshold value.

19. The method of claim 12, wherein the determining of whether to label the image comprises:
determining to label the image for learning the interest network based on the first reliability score and the second reliability score being greater than or equal to a threshold value.

20. The method of claim 12, wherein the determining of the first reliability score and the second reliability score is performed before the detecting of the occlusive object, and
wherein the detecting of the occlusive object comprise detecting the occlusive object based on the first reliability score and the second reliability score being less than a threshold value.
